(19) United States
(12) Patent Application Publication
(10) Pub. No.: US 2023/0123529 A1
(43) Pub. Date: Apr. 20, 2023

(54) METHOD OF TUNING THE ELECTRONIC ENERGY LEVEL OF COVALENT ORGANIC FRAMEWORK FOR CRAFTING HIGH-RATE NA-ION BATTERY ANODE

(71) Applicant: INDIAN INSTITUTE OF SCIENCE EDUCATION AND RESEARCH, Pune, Maharashtra (IN)

(72) Inventors: Sattwick HALDAR, Pune (IN); Ramanathan VAIDHYANATHAN, Pune (IN)

(21) Appl. No.: 17/914,925

(22) PCT Filed: Mar. 27, 2021
(86) PCT No.: PCT/IB2021/052553

§ 371 Date: Sep. 27, 2022

(30) Foreign Application Priority Data
Mar. 28, 2020 (IN) 202021013731

(51) Int. Cl. H01M 4/60; H01M 10/054; H01M 4/66

(52) U.S. Cl. CPC H01M 4/60; H01M 10/054; H01M 4/667; H01M 4/661; H01M 4/663; H01M 2004/027

(57) ABSTRACT

The present invention relates to a covalent organic framework and a covalent organic framework derived Na-ion battery electrode. The present invention further relates to a method of tuning the electronic energy level of covalent organic framework for crafting high-rate Na-ion battery anode and an inclusion of functional modules capable of enhancing the electron accumulation on Covalent Organic Frameworks (COFs) based anodes.

### TECHNICAL FIELD OF THE INVENTION

The present invention relates to method of tuning the electronic energy levels of Covalent Organic Framework to make it work as efficient anodes for Sodium Ion Battery (SIB). Specifically, the present invention relates to a covalent organic framework and a covalent organic framework derived Na-ion battery electrode. The invention further relates to an inclusion of functional modules capable of enhancing the electron accumulation on Covalent Organic Frameworks (COFs) based anodes.

### BACKGROUND OF THE INVENTION

COFs are crystalline polymers with uniform nanopores. The out-of-plane π-π stacking of the aromatic rings between the COF layers generate hollow cylindrical channels along the c-direction. Their pore size and shape can be tuned by choosing the monomers of desired length and geometry. Meanwhile, their organic backbone favors the stoichiometric incorporation of electrochemically active sites into the framework. This molecular-level designability gives a chance to decorate the entire wall of their cylindrical pores with redox-active functional groups. Their crystalline structure would ensure a periodic distribution of such active sites, while the large nanoporous dimension of the pores ensures easy access to such sites. Also, COF's high surface area helps to store electrical charge via electrical double layer formation. These redox-active COFs become apt electrode candidates for metal-ion batteries. Particularly, in providing the required electronic dynamo for sluggish ions like Na⁺. COF's superior anodic performance in Li-ion batteries with specific capacities surpassing commercial graphite is already known. Typically, graphite is the most used anode in commercial Li-ion batteries. It stores Li-ions by inserting them into its inter-layer spaces. Unfortunately, the Na⁺ ions are too large to fit into these strongly n-stacked graphitic layers. This downright impedes their ionic-diffusion at the anode. As an alternative, hard carbon doped with heteroatoms such as B, N, S and P have been employed as anodes in Na-ions with reasonable success (B doped: 278 mAh/g @0.1 A/g, N doped: 154 mAh/g @l5 A/g, S doped: 182 mAh/g @3.2 A/g, P doped: 108 mAh/g @20 A/g). Nevertheless, even in these improved systems, the relative drop in specific capacity with increasing current density (termed as the rate-performance) needs to be improved.

Alternatively, the graphitic structures of COFs have been exfoliated to improve the diffusion kinetics of the Li-ions within the anodes. This directly improves their rate-performance. Even such an exfoliation process is unable to solve the diffusion issue as the atomic weight and ionic size of the Sodium is quite high compare to Lithium (Li⁺: 0.76 ∈ vs. Na⁺: 1.02 Å). This is why hard carbons with a 3D mesoporous structure are more successful (>280 mAh/g @ 100 mA/g). Yet, the designed enhancement of anodic performance at high current density (236 mAh/g @ 10 A/g) of such hard carbons with atomic-level manipulation is primarily hampered by their amorphous structure. This is where COFs offer huge promise. Recently, a carbonyl functionalized COF with enhanced anodic performance in Sodium Ion Batteries (SIB) was reported in higher current density (135 mAh/g @ 10 A/g). Independently, an acid delamination of COF layers was shown to improve the specific capacity at lower current density in a SIB (200 mAh/g @5 A/g). But such treatments can be harsh and can disrupt the COF structure.

### Objective of the Present Invention

Therefore, it is an objective of the present invention to design and develop fast charging Na-ion battery by atomically manipulating the energy levels of the covalent organic framework based anodes.

Another objective of the present invention is to provide a novel covalent organic framework and preparation thereof.

### SUMMARY OF THE INVENTION

In line with the above objective, the present invention provides Covalent Organic Framework derived Na-ion battery anode, wherein, the Phenyl groups in the COF are by design replaced with pyridyl-tetrazine units to lower the LUMO levels and thereby improving the anodic performance.

Accordingly, in an aspect, the invention provides three COF with a (3+2) framework formed by reacting a C3 symmetry trialdehyde [2,4,6-trihydroxybenzene-1,3,5-tricarbaldehyde] with three different C2 symmetry diamine containing terphenyl [(1,1′:4′,1″-terphenyl)-4,4″-diamine], s-tetrazine [4,4′-(1,2,4,5-tetrazine-3,6-diyl)dianiline] and s-tetrazine bispyridine [5,5′-(1,2,4,5-tetrazine-3,6-diyl)bis (p yridin-2-amine)], hereto referred as IISERP-COF16, IISERP-COF17 and IISERP-COF18, respectively.

In first aspect, the present invention relates to a covalent organic framework comprising of plurality of 2,4,6-trihydroxybenzene-1,3,5-tricarbaldehyde and plurality of terphenylamine, s-tetrazinedianiline, s-tetrazine bispyridines in an extended layered covalent framework.

In another aspect of the present invention, the terphenylamine is (1,1′:4′,1″-terphenyl)-4,4″-diamine, s-tetrazinedianiline is 4,4′-(1,2,4,5-tetrazine-3,6-diyl)dianiline, and the s-tetrazine bispyridines is 5,5′-(1,2,4,5-tetrazine-3,6-diyl)bis(pyridin-2-amine).

In another aspect of the present invention, the covalent organic framework is based on 2,4,6-trihydroxybenzene-1,3,5-tricarbaldehyde and (1,1′:4′,1″-terphenyl)-4,4″-diamine; 2,4,6-trihydroxybenzene-1,3,5-tricarbaldehyde and 4,4′-(1,2,4,5-tetrazine-3,6-diyl)dianiline; and 2,4,6-trihydroxybenzene-1,3,5-tricarbaldehyde and 5,5′-(1,2,4,5-tetrazine-3,6-diyl)bis(pyridin-2-amine).

In another aspect of the present invention, the covalent organic framework is selected from IISERP-COF16, IISERP-COF17 and IISERP-COF18.

In yet another aspect, the present invention relates to a method of preparation of a covalent organic framework comprising the steps of:
(a) reacting 2,4,6-trihydroxybenzene-1,3,5-tricarbaldehyde with terphenylamine, or s-tetrazinedianiline, or s-tetrazine bispyridines in a solvent in presence of acetic acid at a temperature in the range of 120° C. to 140° C. for a time period of 2 days to 7 days; and
(b) cooling the reaction mixture to room temperature to obtain a crude product; and
(c) optionally purifying the crude product using Soxhlet extraction to obtain the covalent organic framework.

In another aspect of the present invention, the solvent used in the preparation of covalent organic framework is selected from dioxane, mesitylene, tetrahydrofuran, dimethylformamide, acetonitrile, ethyl acetate or a mixture thereof.

In another aspect of the present invention, the time period of the reaction of step (a) in the preparation of covalent organic framework is 5 days.

In yet another aspect, the present invention relates to a covalent organic framework derived Na-ion battery electrode comprising of a covalent organic frame work based on 2,4,6-trihydroxybenzene-1,3,5-tricarbaldehyde and (1,1′:4′,1″-terphenyl)-4,4″-diamine; 2,4,6-trihydroxybenzene-1,3,5-tricarbaldehyde and 4,4′-(1,2,4,5-tetrazine-3,6-diyl)dianiline; and 2,4,6-trihydroxybenzene-1,3,5-tricarbaldehyde and 5,5′-(1,2,4,5-tetrazine-3,6-diyl)bis(pyridin-2-amine) coated with Na metal.

In another aspect of the present invention, the covalent organic framework in the covalent organic framework derived Na-ion battery electrode is based on 2,4,6-trihydroxybenzene-1,3,5-tricarbaldehyde and 5,5′-(1,2,4,5-tetrazine-3,6-diyl)bis(pyridin-2-amine). In another aspect of the present invention, the covalent organic framework in the covalent organic framework derived Na-ion battery electrode is IISERP-COF18.

In yet another aspect, the present invention relates to a method of preparation of a covalent organic framework derived Na-ion battery electrode, wherein the method comprising the step of:
(a) dispersing a covalent organic framework in ethanol to obtain ethanolic dispersion of the covalent organic framework;
(b) coating the ethanolic dispersion of the covalent organic framework on a carbon paper; and
(c) drying the carbon paper in vacuum for 12-24 hours to obtain electrode; and
(d) fabricating the electrode using Na metal to obtain the covalent organic framework derived Na-ion battery electrode.

In another aspect of the present invention, the carbon paper used in the method of preparation of a covalent organic framework derived Na-ion battery electrode is carbon coated aluminium foil.

In another aspect, the present invention provides a method for the development of anodes for Na-ion battery using the bispyridine-tetrazine containing COF, which are tuned to have low-energy LUMO levels. More specifically, the pyridyl-tetrazine units in a COF generate LUMO levels of low energy wherein, electrons accumulate favourably under an applied potential. These electron-dosed LUMO levels provide surplus driving force for otherwise sluggish Na⁺ ions to flow in from the electrolyte to this anodic COF. The improved diffusion kinetics of the Na⁺ ions increases the rate-performance or the charging-recharging rates of the battery.

In yet another aspect, the inventors have demonstrated the excellent anodic performance of this COF-based Na-ion battery using a prototype 2032 coin-cell.

More specifically, the COFs used in the present invention has ˜37 Ang. uniformly sized ordered single-sized mesopores. These pores are majorly lined by only carbon, oxygen and hydrogen atoms in IISERP-COF16, by carbon, oxygen, nitrogen (tetrazine) and hydrogen in IISERP-COF17 and by carbon, oxygen, nitrogen (bispyridine-tetrazine) and hydrogen in IISERP-COF18. The ratio of the C/N/O/H has been systematically varied by the stoichiometric combination of the monomeric modules.

With the increase of nitrogen content in the COF backbone the color of the isostructural COFs changes from golden yellow to brown (Scheme 1 and FIG. 2B). Concomitantly, the Ultra Violet (UV)—visible absorption maxima shifts from lower wavelength to higher wavelength as we go from 1 to 3 (FIG. 2C). Each of the UV band has a long tail in the higher wavelength region, which usually contributes majorly to the color of the COFs. To gain more evidence about color change with the introduction of nitrogenous aromatic ring, we estimated the band gaps using Tauc plots (FIG. 2D). A continuous decrease of band gap from 2.75 to 2.51 to 2.20 eV has been observed with increase of color intensity of the COFs. To add further, the band structure and energy levels were calculated from electrochemical methods, namely the Cyclic Voltammetry (CV). To avoid any interference, the CV measurements were performed in a non-aqueous electrolyte medium (t-butyl-ammonium-hexafluorophosphate dissolved in acetonitrile) using a non-aqueous Ag/Ag⁺ reference and platinum flag counter electrodes (FIG. 2E). The highest oxidation potential provides the energy required to take out one electron from HOMO whereas the lowest reduction potential corresponds to the energy required to provide one electron to the LUMO. These frontier orbitals precisely define the HOMO-LUMO energy levels of the COFs with respect to NHE (Normal Hydrogen Electrode). And it is calculated by converting the potential obtained with respect to Ag-AgCl (FIG. 2F). A continuous decrease of band gap from 2.93 to 2.61 to 2.32 eV has been observed for IISERP-COF16, IISERP-COF17 and IISERP-COF18, respectively. The trend is consistent with the determined optical bandgaps.

Thus without much alternation of the condensed HOMO levels, the LUMO energy levels get more stabilized to lower energy levels with inclusion of nitrogen atoms in the COF framework. Lowering of the LUMO energy levels brings out the possibility of facile reduction of the relatively electron-deficient tetrazine and pyridine moieties. From charge-discharge measurements performed using the coin-cell batteries, the bispyridine-tetrazine COF, IISERP-COF18, with the lowest LUMO energy shows a specific capacity of 340 mAh/g at a high current density of 1 A/g and 128 mAh/g at 15 A/g. Only a 24% drop appears upon increasing the current density from 100 mA/g to 1 A/g, which is the lowest among all the top-performing COF derived Na-ion battery-anodes. Interestingly, the phenyl analogue lacking the N-heteroatom in its backbone does not show such a high performance.

Abbreviations:

IISERP-COF16 or 1: COF based on 2,4,6-trihydroxybenzene-1,3,5-tricarbaldehyde and terphenyl [(1,1′:4′,1″-terphenyl)-4,4″-diamine].

IISERP-COF17 or 2: COF based on 2,4,6-trihydroxybenzene-1,3,5-tricarbaldehyde and s-tetrazine [4,4′-(1,2,4,5-tetrazine-3,6-diyl)dianiline].

IISERP-COF18 or 3: COF based on 2,4,6-trihydroxybenzene-1,3,5-tricarbaldehyde and s-tetrazine bispyridine, [5,5′-(1,2,4,5-tetrazine-3,6-diyl)bis(pyridin-2-amine)].

### BRIEF DESCRIPTION OF DRAWINGS

FIG. 1. A: Modelled structures of the (i) IISERP-COF16 (ii) IISERP-COF17 and (iii) IISERP-COF18 prefer an eclipsed configuration with an AA . . . stacking. (Inset) The Selected Area Electron Diffraction (SAED) pattern of COFs observed for higher angle diffraction of 001 planes. F0, F1, F2, and F3 are the redox active functional groups present in IISERP-COFs. Table 1: Total energy and unit cell parameters of geometry and energy optimized COFs. B: Pawley fits of the three COFs with experimental PXRD pattern C: Nitrogen (N₂) sorption isotherms of the COFs measured at 77 K. D: Pore size distribution plots of the COFs obtained from model-independent BJH fit of N₂ desorption at 77K.

FIG. 2. A: Building blocks of polymeric COFs showing the presence of electron rich and electron deficient centers. B: A photograph shows the color of the COFs under visible light. C: UV-visible spectra of COFs showing the absorption maxima. D: Evaluated band gaps of COFs by Tauc plot using UV-visible absorption spectra. E: Cyclic Voltammogram (CV) in non-aqueous three electrode system showing the oxidation and reduction potentials of COFs. F: HOMO-LUMO energy levels of COFs and respective band gaps evaluated from the CV measurements.

FIG. 3. A pictorial representation shows discharging mechanism of a COF derived half-cells (SIB). The presence of sodium ions are near to the sodium metal interphase at OCV. Under applied potential sodium ion starts moving towards the negatively charged COF. Flow of the Sodium ions towards anode induces by accumulation of external negative charge on anode.

FIG. 4. A: CV measurements of COFs derived half cells shows the two steps oxidation reduction of COFs. B: Mechanistic pathway of electrochemical reduction of tetrazine and phluroglucinol units followed by Sodiation under reduced potential. Pyridine-P-ketoenamine core provides the chelation core for sodium. C: A graphical representation of LUMO energy levels shows the energetically favorable electrochemical reduction. D: (i), (ii) and (iii) Charge-discharge profiles of COFs for 250 cycles @ 100 mA/g current density (excluding the initial SEI formations) Capacity retention at high currents. E: Rate performance of COFs from lower to higher current density (hollow spheres denote discharging, solid spheres denote charging) F: Rate performance of COF18 at high current density G: Cycling stability and retention of specific capacity of COFs @1 A/g current density.

FIG. 5. A, B and C: Nyquist plot obtained from potentiostatic impedance measurements of COFs derived half -cells @ OCV, @0.5 V and @0.1. Shaded area shows the decrease of charge transfer resistance with increase of DC bias D: The plot of Zreal vs. the inverse square root of angular frequency (ω) for the COF derived coin-cells (@0.1 V DC voltage). The slopes of the fitted lines represent the Warburg coefficients (σ).

FIG. 6. A: DFT modeled Na@COF structure shows the closest interactions between the anionic COF and the Na⁺ ions. B: Every active site is sandwiched between two crystallographically equivalent Na⁺ sites. C: The 3D framework showing the distribution of Na⁺ ions around the heteroatoms lining the framework.

FIG. 7. ¹H-NMR and ¹³C-NMR of triformylphloroglucinol were recorded in deuterated chloroform and in dimethyl sulfoxide (DMSO-d₆), respectively, at room temperature.

FIG. 8: A: The room temperature ¹H-NMR and ¹³C-NMR of s-tetrazine diamine were recorded in deuterated chloroform and in dimethyl sulfoxide (DMSO-d₆), respectively. B: FT-IR spectra of 4-aminobenzonitrile and s-tetrazinediamine.

FIG. 9: A: ¹H-NMR and ¹³C-NMR of bispyridine-s-tetrazine diaminerecorded in dimethyl sulfoxide (DMSO-d₆) at room temperature. B: ¹H-NMR and ¹³C-NMR of bispyridine-s-tetrazine diamine recorded in dimethyl sulfoxide (DMSO-d₆) at 373 K. C: FT-IR spectra of 6-amino-3-pyridinecarbonitrile and bis-pyridine-s-tetrazine diamine. D: HRMS data of bispyridine-s-tetrazine diamine shows only a single intense peak of [M+H]⁺: 265.19. The exact molecular mass of bispyridine-s-tetrazine diamine (C₁₂H₁₀N₈) is 266.10.

FIG. 10: A: CP MAS ¹³C-NMR spectra of the IISERP-COF16 measured at 500 MHz. a, b, c, d, e, f, g, h are the corresponding peaks positions obtained from the NMR data. (*) denotes the presence of side bands. B: CP MAS ¹³C-NMR spectra of the IISERP-00F17 measured at 500 MHz. a, b, c, d, e, f, g, h are the corresponding peaks positions obtained from the NMR data. (*) denotes the presence of side bands. C: CP MAS ¹³C-NMR spectra of the IISERP-COF18 measured at 500 MHz. a, b, c, d, e, f, g, h, i are the corresponding peaks positions obtained from the NMR data. (*) denotes the presence of side bands.

FIG. 11: Comparison of the FT-IR spectra of IISERP-COFs.

FIG. 12: The general scheme-1 depicts the formation of IISERP-COFs from corresponding monomers. Inset shows the photograph of the COF powders.

### DETAILED DESCRIPTION OF THE INVENTION

The invention will now be described in detail in connection with certain preferred and optional embodiments, so that various aspects thereof may be more fully understood and appreciated.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art.

The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non — claimed element essential to the practice of the invention.

As used herein, the term “Na-ion battery” refers to sodium ion battery.

In general embodiment, the present invention relates to a covalent organic framework and a covalent organic framework derived Na-ion battery electrode. The invention further relates to an inclusion of functional modules capable of enhancing the electron accumulation on Covalent Organic Frameworks (COFs) based anodes.

In an embodiment of the present invention, the covalent organic framework is IISERP-COF16, IISERP-COF17 and IISERP-COF18.

In another embodiment of the present invention, the covalent organic framework is IISERP-COF16.

In another embodiment of the present invention, the covalent organic framework is IISERP-COF17.

In another embodiment of the present invention, the covalent organic framework is IISERP-COF18.

The present invention provides a very novel approach that aims at lowering the energy level of the Lowest Unoccupied Molecular Orbitals (LUMO) or the LUMO derived bands of the Covalent Organic Framework (COF) via atomic-manipulation. The levels are anti-bonding in nature and hence, get filled-up by electrons under an applied potential during battery operation (Charging of a battery). Such electron-accumulated or -dosed LUMO levels, as anodes in metal-ion batteries, generate substantial driving force for the cationic Na⁺ ions to come into the anodic compartment from the electrolyte, thus generating current. This creates sufficient ion-mobility at the anode, making the Na⁺ ions to move rapidly, improving the charging-discharging rates (rate-performance) of the Na-ion battery.

The present invention thus provides Covalent Organic Framework, wherein, the Covalent Organic Framework is designed and developed by using pyridine-tetrazine units that favour low-energy LUMO levels.

In an embodiment, such a COF, with low-energy LUMO levels have been utilized as anodes in Na-ion battery or coin-cells.

Accordingly, in a preferred embodiment, the covalent Organic Framework with low-energy LUMO level comprising plurality of tripodal ligand, i.e., 2,4,6-trihydroxybenzene-1,3,5-tricarbaldehyde and plurality of s-tetrazine bispyridine [5,5′-(1,2,4,5-tetrazine-3,6-diyl)bis(pyridin-2-amine)], in extended layered covalent framework.

In another embodiment, the present invention provides a method to develop anodes by utilizing the COF for Na-ion coin-cells.

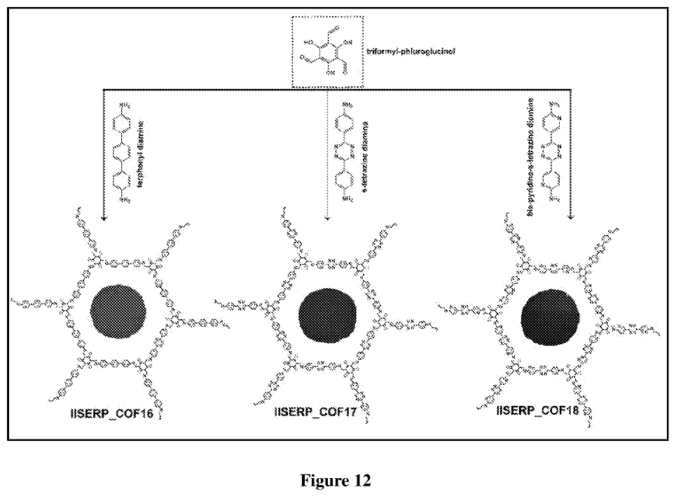

Accordingly, the present invention provides a chemistry for the preparation of these COFs with low-energy LUMO levels to be used as efficient anodes for fast-charging Na-ion batteries. Scheme 1 (FIG. 12) depicts the formation of IISERP-COFs from corresponding monomers. The inset shows the photograph of the COF powders. The active COF, IISERP-COF18, is prepared by reacting a trihydroxy-trialdehyde with bispyridine-tetrazine-diamine in a mixture of dioxane (5.0 mL) and mesitylene (3.0 mL) by heating at 135° C. for 5 days (Scheme 1).

The products thus obtained were purified. The purified COF (IISERP-COF16, IISERP-COF17 and IISERP-COF18) were characterized using CHN analysis, crystallographic modeling, thermal stability, absorption data analysis, etc.

In another embodiment, the present invention relates to a method of preparation of a covalent organic framework comprising the steps of:
(a) reacting 2,4,6-trihydroxybenzene-1,3,5-tricarbaldehyde with terphenylamine, or s-tetrazinedianiline, or s-tetrazine bispyridines in a solvent in presence of acetic acid at a temperature in the range of 120° C. to 140° C. for a time period of 2 days to 7 days; and
(b) cooling the reaction mixture to room temperature to obtain a crude product; and
(c) optionally purifying the crude product using Soxhlet extraction to obtain the covalent organic framework.

According to present invention, the terphenylamine used in the process of preparation of COF is (1,1′:4′,1″-terphenyl)-4,4″-diamine, s-tetrazinedianiline used in the process of preparation of COF is 4,4′-(1,2,4,5-tetrazine-3,6-diyl)dianiline, and the s-tetrazine bispyridines used in the process of preparation of COF is 5,5′-(1,2,4,5-tetrazine-3,6-diyl)bis(pyridin-2-amine). In another embodiment of the present invention, the temperature of the reacting 2,4,6-trihydroxybenzene-1,3,5-tricarbaldehyde with terphenylamine, or s-tetrazinedianiline, or s-tetrazine bispyridines is in the range of 130° C. to 135° C.

In yet another embodiment of the present invention, the solvent is selected from the mixture of dioxane and mesitylene.

In yet another embodiment, the present inventors have utilized this hydrophobic COF to fabricate electrodes by coating an ethanolic dispersion of the COFs on carbon paper. Coating was maintained over a 1×1 cm² area. Then it was dried in vacuum for 24 hrs. The electrodes were subjected to CV measurements in a non-aqueous electrolyte system (t-butyl ammonium hexaflurophosphate dissolved in acetonitrile, tBuNH4PF6/ACN) under argon atmosphere. A non-aqueous Ag/Ag⁺ reference electrode and platinum flag counter electrodes were used. CV measurements were carried in 50 mV/s scan rate from ˜1.8 V to 2.2 potential window.

To evaluate the state of electronic conductivity and resistance during Na⁺ propagation within these three isostructural COFs, potentiostatic impedance were measured. An AC-sweep of 10000 Hz to 10 mHz at 10 mV-rms AC amplitude was implemented on the activated coin-cells. The constant current charge-discharge measurements were performed using AMETEK Battery analyser using VERSA STUDIO (Version 2.61 beta) software. The cyclic voltammetry and potentiostatic electrochemical impedance studies were performed in PARSTAT Multichannel electrochemical workstation.

Impedance data fitting was done using Z-view software (version 3.4).

Characterizations of the COFs:

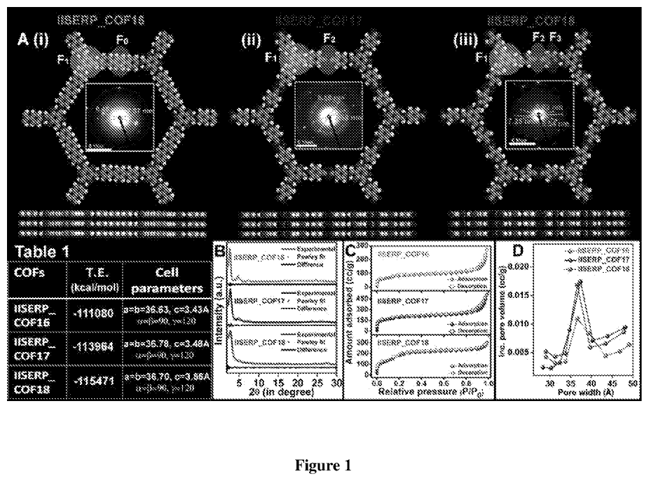

Purity of all the monomers were confirmed from solution state ¹H and ¹³C NMR. The completion of the polycondensation reactions were confirmed by ¹³C solid state NMR studies and IR data analysis of the COFs. With the increase of the nitrogen contents in the framework, the color of the COFs becomes darker brown from golden yellow (Scheme 51). The structural models for all three COFs were built using Materials Studio v. 6.0.51-53 An initial indexing and space group search was performed using the experimental powder X-ray diffraction (PXRD) employing the Reflex module. All three PXRD patterns indexed to a hexagonal cell. A space group search yielded P-6 and P6/m both with well-acceptable Figure of Merit (Table 1). Atomic manipulations were carried out in a cell built using the higher symmetry P6/m setting to obtain an initial polymeric model of the COF with apt connectivity. The final structures were optimized with a periodic tight-binding DFT method (DFTB). Total energies were extracted from the DFTB optimizations (1: eclipsed=−111080; 2: eclipsed=−113964; 3: eclipsed=−115471; kcal/mol/unit cell). The Pawley refinements of the experimental PXRDs against their optimized models yield excellent fits for all the COFs (FIG. 1B). The presence of strategically positioned keto groups of the phloroglucinol units enables its strong O . . . H—N . . . intra-layer hydrogen bonds with the enamine form of the connecting Schiff bonds along ab-plane. The three dimensional structure of the IISERP-COFs have π-stacked columns of resorcinol units and the columns of benzene (for 1), s-tetrazine (for 2), bis-pyridine s-tetrazine rings (for 3) covalently linked by Schiff bonds (FIG. 1A). This creates uniform one dimensional (1D) nano-channels with pores of size ˜38 Å (factoring the van der Waals radii of the atoms) along c-axis, which agrees well with the experimentally determined pore size. Experimental PXRD pattern shows high intensity peaks located at 2θ: 2.65° (for 1), 2.55 (for 2), 2.6 (for 3) for (100) reflections (FIG. 1B). The (003) reflections ˜along the stacking direction is clearly observed at a 2θ˜26.5°. From the

Selected Area Electron Diffraction (SAED) patterns the higher angle reflections can be seen (FIG. 1A insets). The SAED ring diameter (2R)˜6.0 nm corresponds to inter-planar separation distances (3.4 Å) of the eclipsed configuration of the refined structure. This further confirms the crystallinity of this family of polycrystalline covalent organic frameworks. Adsorption-desorption isotherms of N₂ at 77 K, yielded a completely reversible type-2 isotherm for 1, 2 and 3, which approves their expected mesoporous structure (FIG. 1C). A model-independent Barrett-Joyner-Halenda (BJH) fit to desorption branch reveals the presence of uniform ˜36.6, 36.9 and 36.5 Å pores in 1, 2 and 3, respectively (FIG. 1D). These COFs have higher Langmuir surface area (920 m²/g for 1; 1452 m²/g for 2; 1745 m²/g for 3) than Brunauer-Emmett-Teller (BET) surface area. All the powdered samples were subjected to Soxhlet washing using boiling THF/DMF mixture (48 hrs), to get rid of any soluble oligomers. The PXRD and porosity data reproduced well across different batches, confirming that the samples do not have any significant impurity phases.

The characteristic carbonyl (C═O) stretching frequency (1718 cm⁻¹) of the triformyl-phloroglucinol was red-shifted (1630 cm ⁻) and the N—H stretching modes (3388, 3317, 3196 cm ⁻¹) of the primary amine disappeared with the formation of the COFs. It is observed from the IR spectra that the solid powders of the as-synthesized 1 exists predominantly in β-ketoenamine form, which is originated from the tautomerism between the Schiff bonds (—C═N—) and carbonyl (—C═O) units, but 2 and 3 shows presence of enolic form too. The presence of appropriate peaks in the ¹³C solid state NMR spectra of the COFs corresponding to the keto group of f3-keto enamine form (185-190 ppm), pyridine (143-148 ppm) and tetrazine (168 ppm) reveals the functional group integrity maintained by the poly-condensed polymeric structure of the COF. The strong interlayer H-bond formation of f3-ketoenamine form enhances the chemical and thermal stability of 1 (stable up to 410° C.). However, the tetrazine containing COFs, 2 and 3, exhibit relatively lowered thermal stability (gradual weight loss on the Thermogravimertic analysis (TGA) commences at 280° C.). All the COFs show ample chemical stability as confirmed by the PXRD of the samples that were boiled in DMF and treated with acid and base (6M).

Microscopy studies:

Under Field Emission Scanning Electron Microscope (FE-SEM), 1 appears as large smooth surfaced flakes which form a stacked microstructure. While 2 has hexagonal flakes which further aggregate into microstructures resembling petals. 3 has a thick fibrous morphology. In all the cases, the SEM images corroborate with the morphologies observed under the High Resolution Transmission Electron Microscope (HR-TEM). The stacking of the layers becomes visible when viewed at the edges or the thinner portion of the sheets. At higher magnifications, uniform micropores could be observed all across the surface of the COF flakes. A high resolution images from the HR-TEM showed the presence of lattice fringes indicating high crystallinity of these COFs. The cross-sectional view could be observed for few of the crystallites drop-casted on the TEM grid from which the interlayer spacing (3.3 Å) could be determined which matched well with the layer separation distances determined from the energy and geometry optimized structure. Moreover, clear SAED patterns of COFs at 5 1/nm scale confirm the presence of diffraction of [001] planes at higher angle. The lower angle reflections are merged in lower diameter range of the SAED, closer to the bright center of the SAED image (FIG. 1A (insets).

Electronic Energy Levels of the COFs:

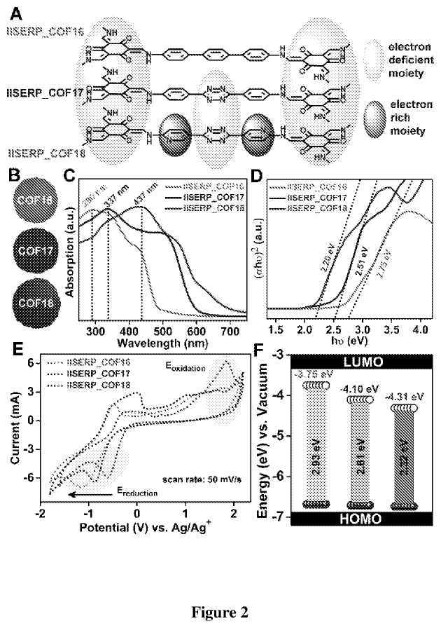

With the increase of nitrogen content in the COF backbone the color of the isostructural COFs changes from golden yellow to brown (Scheme 1 and FIG. 2B). Concomitantly, the Ultra Violet (UV)-visible absorption maxima shifts from lower wavelength to higher wavelength as we go from 1 to 3 (FIG. 2C). Each of the UV band has a long tail in the higher wavelength region, which usually contributes majorly to the color of the COFs. To gain more evidence about color change with the introduction of nitrogenous aromatic ring, the band gaps were estimated using Tauc plots (FIG. 2D). A continuous decrease of band gap from 2.75 to 2.51 to 2.20 eV has been observed with increase of color intensity of the COFs.

To add further, the band structure and energy levels were calculated from electrochemical methods, namely the Cyclic Voltammetry (CV). To avoid any interference, the CV measurements were performed in a non-aqueous electrolyte medium (t-butyl-ammonium-hexafluorophosphate dissolved in acetonitrile) using a non-aqueous Ag/Ag⁺reference and platinum flag counter electrodes (FIG. 2E). Slow scan rates (50 mV/s) in a potential window of −1.8 V to +2.2 V was employed to scrutinize electrochemical oxidation-reduction of the COFs. The highest oxidation potential provides the energy required to take out one electron from HOMO whereas the lowest reduction potential corresponds to the energy required to provide one electron to the LUMO. These frontier orbitals precisely define the HOMO-LUMO energy levels of the COFs with respect to NHE (Normal Hydrogen Electrode). And it is calculated by converting the potential obtained with respect to Ag-AgCl (FIG. 2F).

Hence electrochemically determined band gaps follow the same trend as the optical band gap with some differences in their absolute values. Interestingly, the oxidation potential of these COFs were nearly the same, but the reduction potentials continuously goes to more negative value with the introduction of s-tetrazine ring and bis-pyridine-s-tetrazine ring. Thus without much alternation of the condensed HOMO levels, the LUMO energy levels get more stabilized to lower energy levels with inclusion of nitrogen atoms in the COF framework. Lowering of the LUMO energy levels brings out the possibility of facile reduction of the relatively electron-deficient tetrazine and pyridine moieties. In 3, the conjugation of the lone-pair on the pyridyl ring with the tetrazine units assists the easy electron transfer in between electron deficient tetrazine and carbonyl units of the phloroglucinol units (FIG. 2A). This makes 3 assume the lowest LUMO levels among the three COFs. Importantly, the position of the pyridyl nitrogen (beta position w.r.t hydroxyl moiety) is crucial in gaining maximum conjugation advantage. The relative lowering of the LUMO energy as we move from COF 1 to 3 is quantitatively expressed by how far the reduction potential shifts in the negative axis of the CV (FIG. 2E). Thus, the 3, having the electron accepting LUMO levels sitting at substantially lowered energy carries a true potential to be anode for any ion battery. In an embodiment, the present relates to a method of preparation of a covalent organic framework derived Na-ion battery electrode, wherein the method comprising the step of:
(a) dispersing a covalent organic framework in ethanol to obtain ethanolic dispersion of the covalent organic framework;
(b) coating the ethanolic dispersion of the covalent organic framework on a carbon paper; and
(c) drying the carbon paper in vacuum for 12-24 hours to obtain electrode; and
(d) fabricating the electrode using Na metal to obtain the covalent organic framework derived Na-ion battery electrode.

In another embodiment, the covalent organic framework used in a covalent organic framework derived Na-ion battery electrode is based on 2,4,6-trihydroxybenzene-1,3,5-tricarbaldehyde and (1,1′:4′,1″-terphenyl) -4,4″-diamine ; 2,4,6-trihydroxybenzene-1,3,5-tricarbaldehyde and 4,4′-(1,2,4,5-tetrazine-3,6-diyl)dianiline; and 2,4,6-trihydroxybenzene-1,3,5-tricarbaldehyde and 5,5′-(1,2,4,5-tetrazine-3,6-diyl)bis(pyridin-2-amine).

In an embodiment of the present invention, the covalent organic framework used in a covalent organic framework derived Na-ion battery electrode is IISERP-COF16, IISERP-COF17 and IISERP-COF18.

In an embodiment of the present invention, the covalent organic framework used in a covalent organic framework derived Na-ion battery electrode is IISERP-COF16. In an embodiment of the present invention, the covalent organic framework used in a covalent organic framework derived Na-ion battery electrode is IISERP-COF17.

In an embodiment of the present invention, the covalent organic framework used in a covalent organic framework derived Na-ion battery electrode is IISERP-COF18.

General Principle of SIB:

The diffusion-controlled reaction/insertion mechanism in SIB is much more sluggish compare to Lithium Ion Batteries (LIB) because of the higher atomic weight and ionic radii of Na, thus requires enhanced driving force. If the negative charge of the anodic compartment can be enhanced via chemical manipulation, this can be achieved.

Half-Cell CV Measurements:

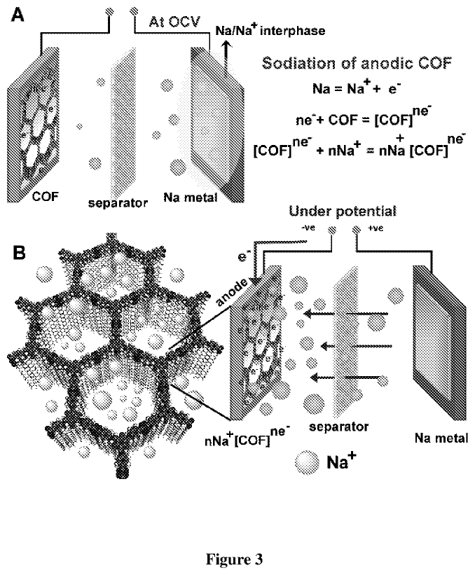

To verify this, half-cell measurements using the COF-derived SIB were performed. The Na-metal plate was employed as a Na⁺ ion source giving an OCV for Na/Na⁺ of 2.75 V (FIG. 3). Now when a negative potential is applied to the anode, this lowers the overall potential of the cell from the OCV and under this potential difference the Na→Na⁺ oxidation is favored and the Na⁺ ions from the electrolyte combines with the electrons at the anode surface. However, the success lies in making this operation occur at a lower potential and in making the Na⁺ diffuse rapidly towards and into the anode. This can be achieved if the anodic surface can be made to accumulate electrons rapidly when connected to the potential source and such negatively biased anode becomes a swift attractor of the incoming Na⁺ ions, during the discharging process.

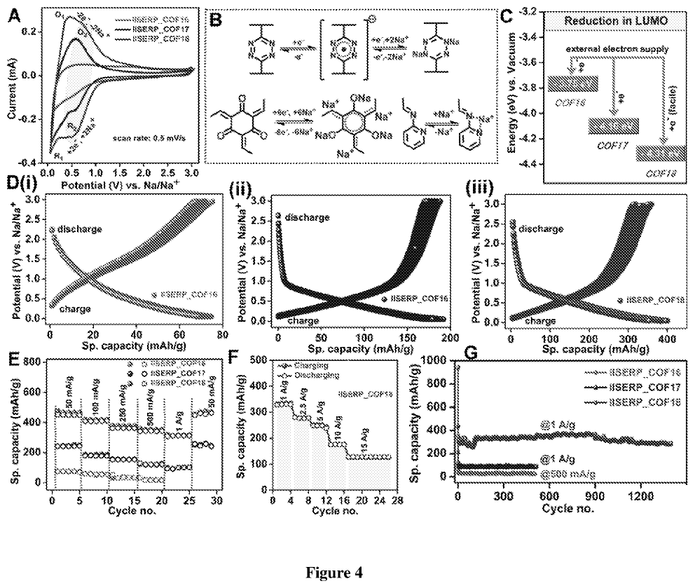

Abundance of the redox active functional groups (keto groups, pyridine nitrogen) all along the walls of the porous nanochannel and presence of highly electron deficient s-tetrazine ring shows ample potential to use these COFs as anode in half cell SIB (FIG. 3). A slurry made by mixing 65% COF (1/2/3): 25% conducting carbon: 10% polyvinylidene difluoride in N-methylpyrollidone (NMP) solution was coated on carbon coated aluminum foil and cut in the size of 2032 coin-cell to use as anode. The half-cell devices were fabricated using Na metal as the reference and 1 (M) NaPF6 in 1:1 EC-DMC (2% FEC) soaked Whatman paper as the separator. The OCVs of the coin-cells came near about 2.65 V due to Na/Na⁺ interface formation on Na metal electrode. To understand the Sodiation and de-Sodiation mechanisms, the CVs of the coin-cells were measured within the potential window from 0.05 to 3 V (FIG. 4A). When the CVs of the COFs recorded at 0.5 mV/s were compared, we find the insertion of sodium during discharging happening through two-step processes for 2 and 3 at 0.1 V (R₁/O₁) and at 0.5 V (R₂/O₂). But 1 displays very little current output even at very low potential at 0.1 V (R₁/O₁) (FIG. 4A). The only molecular-level functional dissimilarity of 1 with respect to 2 of and 3 is the absence of π-stacked s-tetrazine ring throughout the nano-channel. This leaves a marked impact on the Sodiation process, making the 1 the slowest with most sluggish insertion of Na⁺ into the nano-pores. The participation of the tetrazine rings in the redox-assisted Sodiation process is evident from the CV peak at 0.5 V (R₂/O₂). During the discharge process, the anode becomes negatively charged with the applied potential, the flowing in electrons are favourably accommodated by the e-deficient s-tetrazine units of the 2 and 3. The electronic reduction of the 2 and 3 goes via a two closely spaced electron transfer steps. Thus, finally each s-tetrazine unit accommodates 2e- (FIG. 4B). Then two Na⁺ moves from electrolyte towards the negatively charged tetrazine segment to balance the charge on the COF surface/pores. The inventors believe that the ease of reduction of the anodic COFs definitely depends on the stabilization of the LUMO energy level. In 3, the electron incorporation on tetrazine units becomes even more energetically favorable and facile when conjugated to a pyridine ring, which lowers the LUMO level even more (FIG. 2A, FIG. 2C). The high surface area of COF definitely has role in uniformly dispersing this accumulating electrons on the COF-coated anodic surface. The highest sp. capacity near about 410 mAh/g @100 mA/g was achieved by 3 among these three COFs. While, 2 and 1 shows 195 mAh/g and 90 mAh/g, respectively. 3 shows ˜90% columbic efficiency (FIG. 4D (i), (ii) and (iii)). Moreover, potentiostatic charge-discharge profiles of the COFs also corroborate with the characteristic voltage plateau from 0.8 to 0.05 V observed in CVs. 2 and 3 possess a prominent reversible redox activity with comparable voltage plateau at identical potential region, which is unlike 1. A perfect match of the reduction peak in CV with the discharging capacity of the COFs helped to estimate the no of sodium ion intake during

Sodiation process. And the results comes out with almost five-fold enhancement of the sodium acceptance in 3 compare to 1 and two fold compare to 2 due to the presence of bispyridine-s-tetrazine backbone in the nano-channel of 3. The redox activity at the oxygen rich phluroglucinol ring contributes too. In 3, there is the possibility of better chelation of sodium ions in between the phluroglucinol oxygen, pyridinal-nitrogen and f3-keto enamine nitrogen (FIG. 3). This sets-up a chemically-compelled adsorptive sites in 3, in contrast, in 1 most of the Na⁺ insertion is physisorptive. Also the phluroglucinol ring could have some redox activity towards Na⁺ (peak at 1.7 V).

It is evident that all three COFs owing to their good surface areas can show capacitive storage with the superior redox activity, but the diffusion controlled storage is influenced by mass transfer of sodium. To compartmentalize these contributions, the CV peak currents at variable scan-rates were measured and fitted to the Power law obeys the Cottrell's equation with a ‘b’ value of 0.95 at 0.5V (R₂/O₂) and 0.75 at 0.1 V (R₁/O₁). So the participation of reduced tetrazine ring followed by Sodiation of redox active pyridine nitrogen and phluroglucinol ring happens via complete surface induced pathway. Nevertheless, at very low potential, some contribution comes from the Sodium insertion into the pores, most likely via a diffusion controlled pathway.

The electronically driven force created at the anode assists the rapid movement of the Na⁺ ions at the surface as well as into the pores of the COF anodes. This enables achieve excellent rate performance. Even at a current density of 1 A/g, the COFs (2 and 3) retains about ˜80% of the sp. capacity obtained at 100 mA/g, whereas 1 fails at high current inputs (FIG. 4E). Notably 3 is able to deliver 127 mAh/g sp. capacity even at extreme high scan rate of 15 A/g (FIG. 4F). It is impressive to see the COF's (3) stability towards high electron accumulation and rapid redox process at these high current densities. The electrochemical cyclic stability of the 3 was confirmed from complete retention of its redox activity even after 100 charge-discharge cycles (@100 mA/g) without any distortion of voltage plateau and 98% retention of its capacity (340 mAh/g) even after 1400 charge-discharge cycles at 1 A/g (FIG. 4G). Likewise, the 2 also possess excellent stability. Meanwhile, 1 loses most of its sp. capacity even @500 mA/g.

Lowered Resistance to Charge-Transfer in 3 Conferred from AC-Impedance and DC-Measurements:

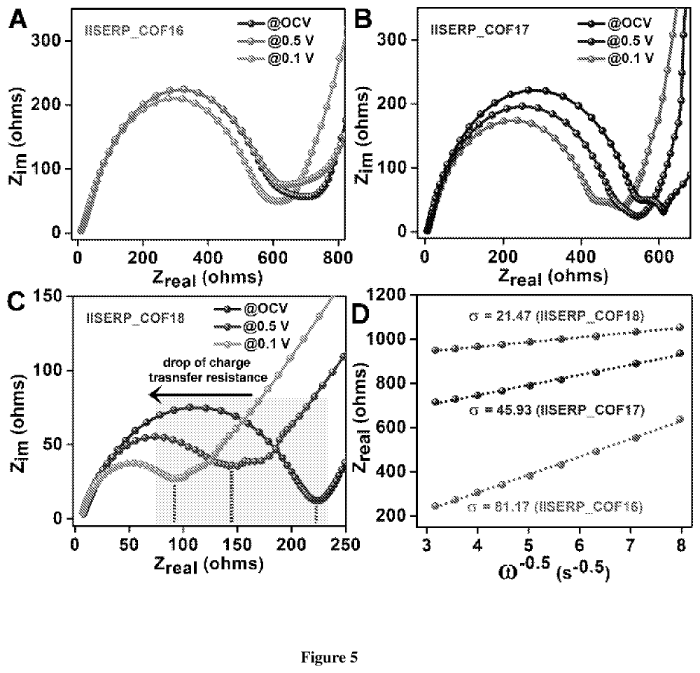

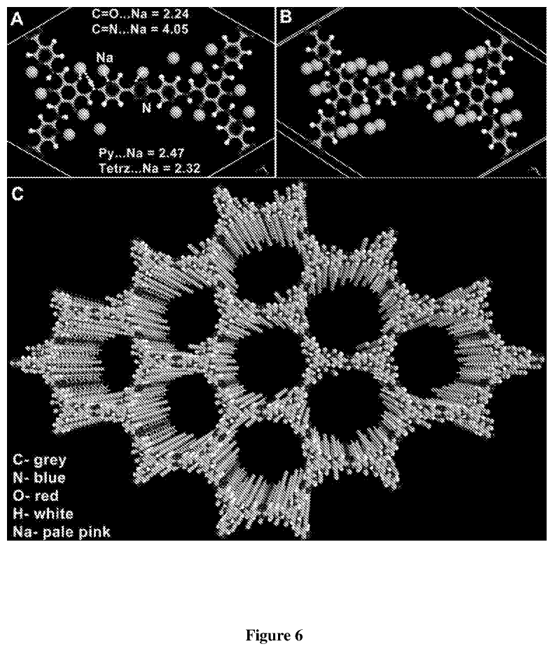

To evaluate the state of electronic conductivity and resistance during Na⁺ propagation within these three isostructural COFs, potentiostatic impedance were measured. An AC-sweep of 10000 Hz to 10 mHz at 10 mV-rms AC amplitude was implemented on the activated coin-cells. Unlike 1 and 2, the presence of relatively electron-rich (pyridine ring) next to electron deficient (tetrazine ring) centers increases the in-plane electronic conductivity of 3 via a strategic push-pull mechanism (FIG. 2A). This is verified by a three-times lowered semicircle diameters of 3 compared to 1 in the Nyquist plots (resistances of 225 for 3 vs. 750 for 1 vs. 620 S2 for 2 was observed at OCV itself, FIG. 5A, 5B, 5C). This is indicative of a lowered charge-transfer resistance. The appearance of a second semi-circle (obtained in lower voltages of 0.5 V and 0.1 V) in the Nyquist plots of 2 and 3 is due to the diffusion resistivity of Na⁺ when it travels through the electrode-electrolyte interphase. To further understand the advantage of having electron-deficient active sites on the anode, potentiostatic impedance of the COF derived coin-cells were measured under three different applied DC voltages i.e. @Na/Na⁺=2.6 V (OCV); @0.5 V (Ered. of tetrazine); @0.1 V (Einsert. of Na⁺) (FIGS. 5A, 5B and 5C). The decrease of the intrinsic resistances of 2 and 3 with a gradual reduction of the applied potential (discharging) indicates the excellent responsive charge-transfer lowering of the 2 and 3. As anticipated, 1 became almost silent to the change of the applied potential. The abrupt decrease of resistivity of 3 after applying the Sodiation potential, most likely arises from the easy mass transfer at the electron rich LUMO levels confined on the tetrazine ring. The more amount of Sodiation makes the structure electronically conducting with time. Moreover, among these COFs, the Warburg resistance (a) at 0.1V (after Einsert. of Na^{t})) is the lowest for 3 (FIG. 5D), suggesting that the diffusion coefficient of Na⁺ (D_{Na+}) increases in conjunction with electron acceptance capability of the COFs (following D_{Na+} α 1/σ²). The diffusion coefficient of 3 is twofold higher than 2 and fourfold higher than 1. So the presence of bispyridine-tetrazine segment makes the nano channel of 3 suitable for easy Sodium transport during the electronic reduction of electron-deficient tetrazine ring.

The following examples are presented to further explain the invention with experimental conditions, which are purely illustrative and are not intended to limit the scope of the invention.

### EXAMPLE 1

General Information

General Remarks:

Phloroglucinol, 4-aminobenzonitrile, 6-amino-3-pyridinecarbonitrile, terphenyl diamine were purchased from Sigma Aldrich; hexamine and trifluoroacetic acid (TFA) were purchased from Avra Synthesis Pvt Ltd. All other reagents were of analytical grade. All chemicals were used without any further purification.

Powder X-Ray Diffraction:

Powder XRDs were carried out using a full-fledged Bruker D8 Advance and Rigaku Miniflex instruments. The data analysis was performed using the Reflex module of the Materials Studio V6.0.

Thermo-Gravimetric Analysis:

Thermo-gravimetric analysis was carried out on NETSZCH TGA-DSC system. The TGAs were done under N2 gas flow (20m1/min) (purge +protective) and samples were heated from RT to 600° C. at 5K/min.

¹³C Solid-State Nuclear Magnetic Resonance (NMR) Spectroscopy:

High-resolution solid-state NMR spectrum was recorded at ambient pressure on a Bruker AVANCE III spectrometer using a standard CP-TOSS pulse sequence (cross polarization with total suppression of sidebands) probe with 4 mm (outside diameter) zirconia rotors. Cross-polarization with TOSS was used to acquire ¹³C data at 100.37 MHz. The ¹³C ninety-degree pulse widths were 4 μs. The decoupling frequency corresponded to 72 kHz. The TOSS sample-spinning rate was 5 kHz. Recycle delays was 2 s.

Infra-Red Spectroscopy:

IR spectra were obtained using a Nicolet ID5 attenuated total reflectance IR spectrometer operating at ambient temperature. The solid state IR spectra were recorded using KBr pellets as background.

Field Emission-Scanning Electron Microscopy (FE-SEM):

Electron Microscope with integral charge compensator and embedded EsB and AsB detectors. Oxford X-max instruments 80 mm². (Carl Zeiss NTS, Gmbh), Imaging conditions: 2 kV, WD=2 mm, 200 kX, Inlens detector. For SEM images, as an initial preparation, the samples were ground thoroughly, soaked in ethanol for 30 min. and were sonicated for 2 hrs. These well-dispersed suspensions were drop casted on silicon wafer and dried under vacuum for at least 12 hrs.

High Resolution Transmission Electron Microscopy (HR-TEM):

Transmission electron microscopy (TEM) was performed using JEM 2200FS TEM microscope operating at an accelerating voltage of 200 kV). The diffractograms were recorded at a scanning rate of 1° min-1 between 20° and 80°.

Adsorption Study

Adsorption studies were carried out using a Micromeritics 3-FLEX pore and surface area analyser.

Electrochemical Measurements:

The constant current charge-discharge measurements were performed using AMETEK Battery analyser using VERSA STUDIO (Version 2.61 beta) software. The cyclic voltammetry and potentiostatic electrochemical impedance studies were performed in PARSTAT Multichannel electrochemical workstation.

Impedance data fitting was done using Z-view software (version 3.4).

### Example 2

Monomer and COF Synthesis:

### Synthesis of 2, 4, 6-triformylphloroglucinol

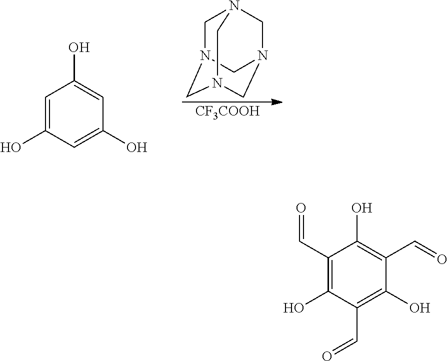 [SMILES: Oc1cc(O)cc(O)c1 ; "CF3COOH" ; C1N2CN3CN1CN(C2)C3 ; O=Cc1c(O)c(C=O)c(O)c(C=O)c1O]

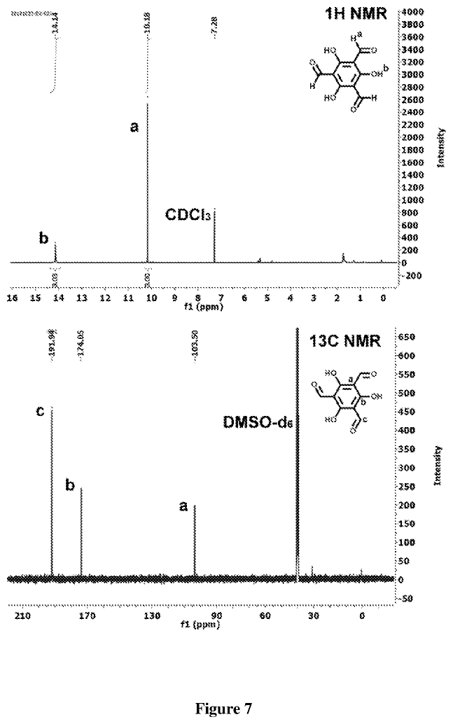

Trifluoroacetic acid (90 mL) was added to dried phloroglucinol (6.014 g) and stirred for 15 minutes to obtain a white suspension. Then hexamine (15.098 g) was added to the suspension. The resulting solution was heated at 100° C. for 2.5 h under N₂ atmosphere and the color of the suspension changed to dark brownish. To hydrolyse the compound, 150 mL of 3N HCl was added with heating at 100° C. for 1 h. The color of the dark turbid solution became clear. After cooling to room temperature, the compound was filtered through a celite flash column. The resulting filtrant was extracted using 350 mL dichloromethane and dried over magnesium-sulfate and then filtered. The solvent was evaporated by rotary evaporation, giving an off-white (yield 1.7 g) powder. The compound was recrystallized in hot DMF and characterization was done using ¹H and ¹³C NMR (FIG. 7).

### Synthesis of s-tetrazine diamine

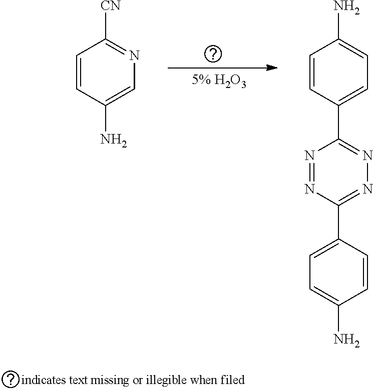 [SMILES: N#Cc1ccc(N)cn1 ; Nc1ccc(-c2nnc(-c3ccc(N)cc3)nn2)cc1]

4-Amino-benzonitrile (8 g) was dissolved in ethanol (20 mL). Hydrazine hydrate (con.90%, 15 mL) and 4 g of sulphur powder was then added to the solution. The solution was kept for stirring at 90° C. for 8 hrs until a bright golden yellow colored thick suspension was observed.

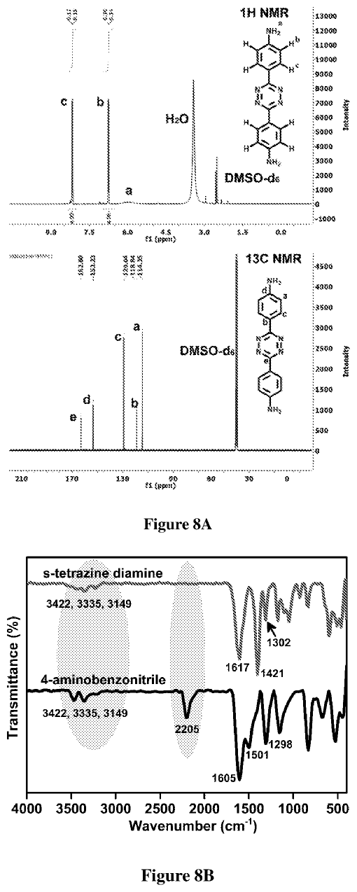

The suspension was filtered and washed with ethanol and acetone multiple times and kept for vacuum drying overnight. The bright yellow powder was dispersed in dry DMSO by stirring and was subjected to an overnight O₂ purge. To this oxidized compound, distilled water (150 mL)was added to precipitate out a bright-red product. The filtered and dried red powder was dispersed in 5% H₂O₂ solution to oxidize fully. The bright red coloured product was isolated by centrifugation and dried in vacuum for 12 hrs. The product was washed with acetone and characterised by ¹H and ¹³C NMR (FIG. 8A) and IR studies (FIG. 8B).

TABLE S1
Comparison of characteritics IR frequencies.

| | | | N—H | | |
|---|---|---|---|---|---|
| | NH₂ | | bend | | |
| | primary | C≡N | Primary | C═C | C—N |
| | amine | Nitrile | amine | bond | bond |
| | (cm⁻¹) | (cm⁻¹) | (cm⁻¹) | (cm⁻¹) | (cm⁻¹) |
| 4- | 3422, 3335, | 2205 | 1605 | 1501 | 1298 |
| aminobenzonitrile | 3149 | | | | |
| s-tetrazine | 3422, 3335, | absent | 1617 | 1421 | 1302 |
| diamine | 3149 | | | | |

Absence of IR frequencies of nitrile groups in s-tetrazine diamine confirms the formation of tetrazine ring.

### Synthesis of bispyridine-s-tetrazine diamine

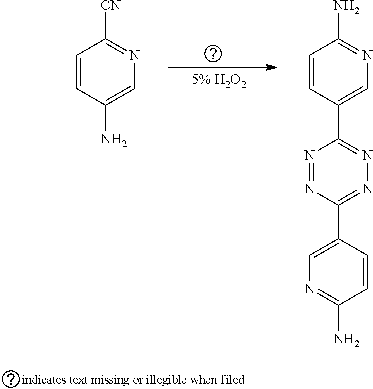 [SMILES: N#Cc1ccc(N)cn1 ; Nc1ccc(-c2nnc(-c3ccc(N)nc3)nn2)cn1]

6-Amino-3-pyridinecarbonitrile (8 g) was dissolved in ethanol (20 mL). Hydrazine hydrate (con.90%, 20 mL) and 4 g of sulphur powder were added to it. The solution was kept for stirring at 90° C. for 8 hrs until a bright golden yellow colored thick suspension was observed.

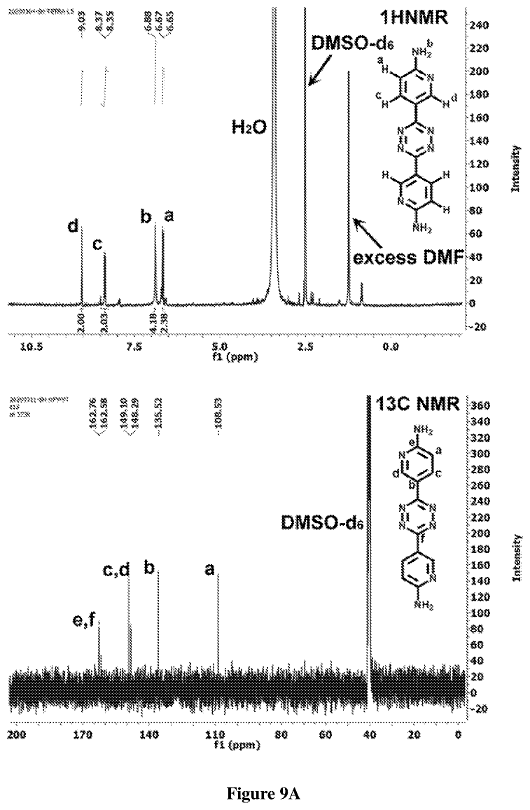

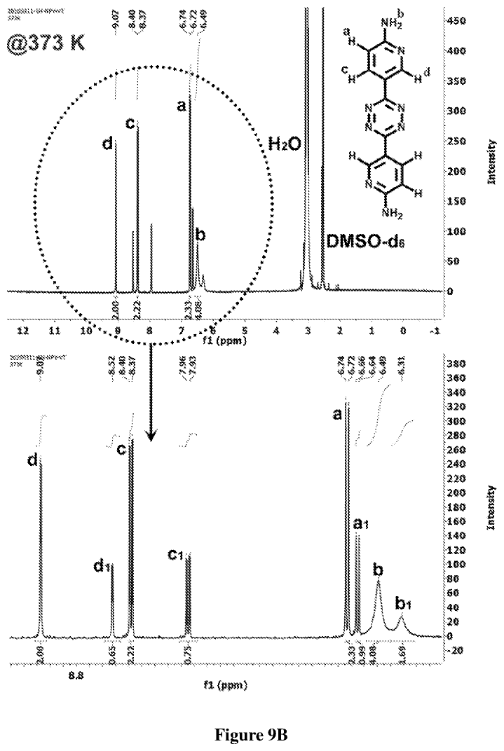

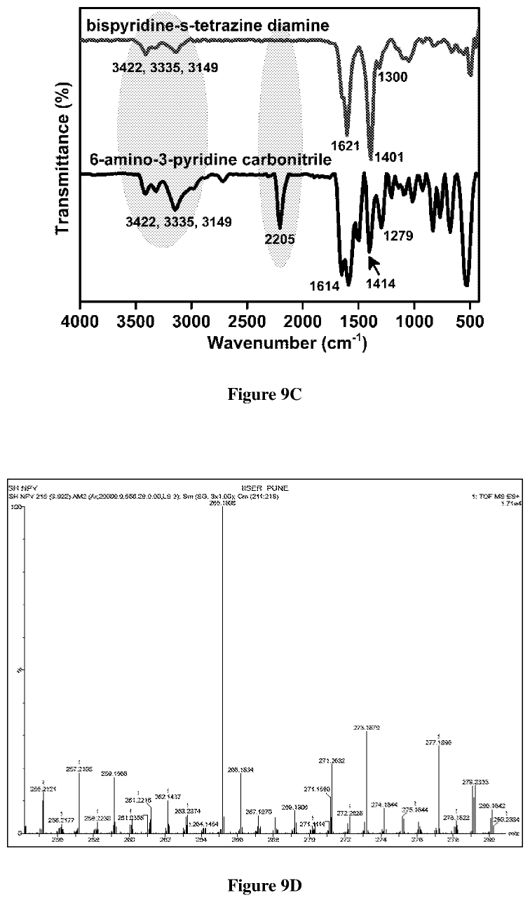

This suspension was filtered and washed with ethanol and acetone multiple times and kept for an overnight vacuum drying. The yellowish-orange powder was dispersed in dry DMSO by stirring and O₂ was purged into the dispersion overnight to oxidize the product. Distilled water (150 mL) was added to it to precipitate out the red product. The filtered and dried red powder was dispersed in 5% H₂O₂ solution to oxidize fully. The dark red colored product (with yield of 70%) was isolated by centrifugation and dried in vacuum for 12 hrs. The product was washed with dimethyl-formamide and characterised by ¹H and ¹³C NMR (FIG. 9A and B), IR studies (FIG. 9C) and HRMS (FIG. 9D). The solubility of bispyridine-s-tetrazine diamine is very less in any organic solvent. But with the increase of temperature it solubilizes in (DMSO-d₆). Two different isomeric peaks were observed with systematic shifts. The ratio of the intensities of two sets of isomeric peaks (a, b, c, d) and (a₁, b₁, c₁, d₁) is 3:1. So the isomers coexist as a mixture with a 3:1 concentration ratio. The probability of the presence of any unreacted product was discarded as HRMS data showed a single molecular weight.

TABLE S2
Comparison of characteritic IR frequencies.

| | | | N—H | | |
|---|---|---|---|---|---|
| | NH₂ | | bend | | |
| | primary | C≡N | Primary | C═C | C—N |
| | amine | Nitrile | amine | bond | bond |
| | (cm⁻¹) | (cm⁻¹) | (cm⁻¹) | (cm⁻¹) | (cm⁻¹) |
| 6-amino-3- | 3422, 3335, | 2205 | 1614 | 1414 | 1279 |
| pyridinecarbonitrile | 3149 | | | | |
| bispyridine s- | 3422, 3335, | absent | 1621 | 1401 | 1300 |
| tetrazine diamine | 3149 | | | | |

Absence of IR frequencies of nitrile groups in bispyridine-s-tetrazine diamine confirms the formation of tetrazine ring.

### Synthesis of IISERP-COF16

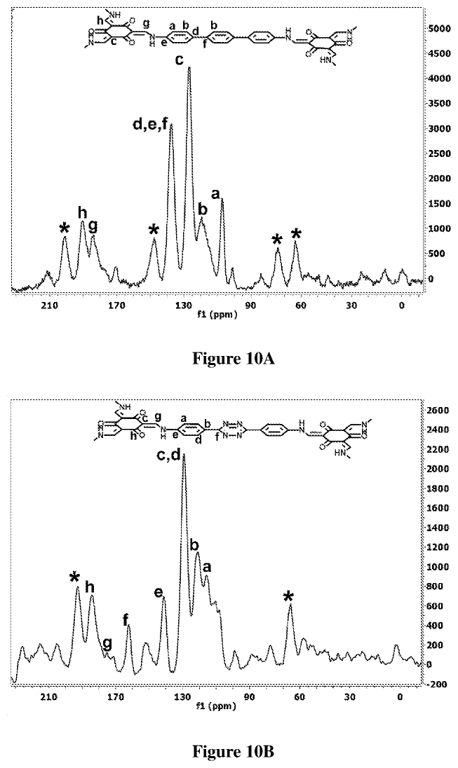

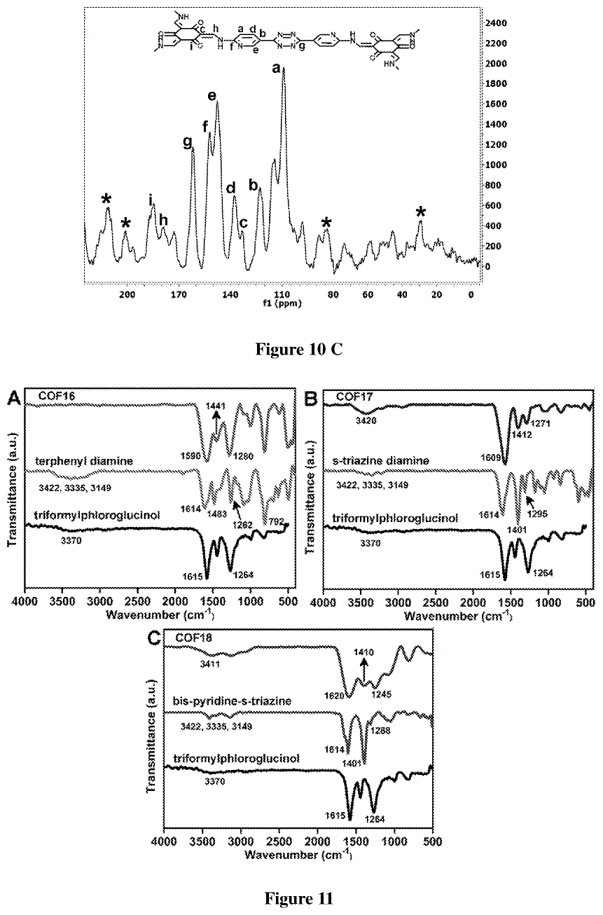

2,4,6-Triformyl-phloroglucinol (65 mg, 0.3 mmol) and terphenyl-diamine (116 mg, 0.45 mmol) were weighed into a Pyrex tube and were dissolved in dioxane (6.0 mL) and mesitylene (3.0 mL) and stirred until a homogeneous yellow colour was observed. To this mixture, 1.0 mL of 0.6 M acetic acid was added. Then the Pyrex tube was flash frozen in a liquid nitrogen bath and sealed. The Pyrex tube along with its contents was placed in an oven at 135° C. for 5 days and gradually cooled to room temperature over 12 hrs. This yielded about 140 mg of bright yellow coloured solid which was washed with hot DMF, dioxane, Me0H, acetone and THF (85%, isolated yield). This product was also subjected to a Soxhlet extraction using hot DMF/methanol/THF as solvent and the solid filtered was characterized by ¹³C solid state NMR (FIG. 10A) and IR (FIG. 11).

### Synthesis of IISERP-COF17

2,4,6-Triformyl-phloroglucinol (65 mg, 0.3 mmol) and s-tetrazine-diamine (118 mg, 0.45 mmol) were weighed into a Pyrex tube and were dissolved in dioxane (6.0 mL) and mesitylene (3.0 mL) and stirred until a homogeneous red colour was observed. To this mixture, 1.0 mL of 0.6 M acetic acid was added. Then the Pyrex tube was flash frozen in a liquid nitrogen bath and sealed. The Pyrex tube along with its contents was placed in an oven at 135° C. for 5 days and gradually cooled to room temperature over 12 hrs. This yielded about 130 mg of bright yellow coloured solid which was washed with hot DMF, dioxane, MeOH, acetone and THF (70%, isolated yield). This product was also subjected to a Soxhlet extraction using hot DMF/methanol as solvent and filtered solid was characterized by ¹³C solid state NMR (FIG. 10B) and IR (FIG. 11).

### Synthesis of IISERP-COF18

2,4,6-Triformyl-phloroglucinol (65 mg, 0.3 mmol) and bispyridine-s-tetrazine-diamine (120 mg, 0.45 mmol) were weighed into a Pyrex tube and were dissolved in dioxane (5.0 mL) and mesitylene (3.0 mL) and stirred until a red colour was observed. To this mixture, 1.0 mL of 0.8 M acetic acid was added. Then the Pyrex tube was flash frozen in a liquid nitrogen bath and sealed. The Pyrex tube along with its contents was placed in an oven at 135° C. for 5 days and gradually cooled to room temperature over 12 hrs. This yielded about 175 mg of bright yellow coloured solid which was washed with hot DMF, dioxane, MeOH, acetone and THF (90%, isolated yield). This product was also subjected to a Soxhlet extraction using hot DMF/methanol as solvent and filtered solid was characterized by ¹³C solid state NMR (FIG. 10C) and IR (FIG. 11).

TABLE S3
IR data analysis of IISERP-COFs

| | | carbonyl | C═C | C—N |
|---|---|---|---|---|
| | Enolic OH | (C═O) | bond | bond |
| COF-Name | (cm⁻¹) | (cm⁻¹) | (cm⁻¹) | (cm⁻¹) |
| IISERP-COF16 | absent | 1590 | 1441 | 1280 |
| IISERP-COF17 | 3420 | 1609 | 1412 | 1271 |
| IISERP-COF18 | 3411 | 1620 | 1410 | 1245 |

The enolic hydroxyl groups present in COF17 and COF18 are rapidly interconvertible to β-ketoenamine form.

1. A Covalent Organic Framework comprising of a plurality of 2,4,6-trihydroxybenzene-1,3,5-tricarbaldehyde and a plurality of terphenylamine, s-tetrazinedianiline, s-tetrazine bispyridines in an extended layered covalent framework.

2. The covalent organic framework as claimed in claim 1, wherein the terphenylamine is (1,1′:4′,1″-terphenyl)-4,4″-diamine, the s-tetrazinedianiline is 4,4′-(1,2,4,5-tetrazine-3,6-diyl)dianiline, and the s-tetrazine bispyridines is 5,5′-(1,2,4,5-tetrazine-3,6-diyl)bis(pyridin-2-amine).

3. The covalent organic framework as claimed in claim 1, wherein the covalent organic framework is based on 2,4,6-trihydroxybenzene-1,3,5-tricarbaldehyde and (1,1′:4′1″-terphenyl)-4,4″-diamine; 2,4,6-trihydroxybenzene-1,3,5-tricarbaldehyde and 4,4′-(1,2,4,5-tetrazine-3,6-diyl)dianiline; 2,4,6-trihydroxybenzene-1,3,5-tricarbaldehyde and 5,5′-(1,2,4,5-tetrazine-3,6-diyl)bis(pyridin-2-amine), or combinations thereof.

4. The covalent organic framework as claimed in claim 1, wherein the covalent organic framework is selected from IISERP-00F16, IISERP-00F17, IISERP-COF18, or combinations thereof.

5. A method of preparation of a covalent organic framework comprising the steps of:
(a) reacting 2,4,6-trihydroxybenzene-1,3,5-tricarbaldehyde with terphenyl amine, s-tetrazinedianiline, or s-tetrazine bispyridines in a solvent in presence of acetic acid at a temperature in the range of 120° C. to 140° C. for a time period of 2 days to 7 days;
(b) cooling the reaction mixture to room temperature to obtain a crude product; and
(c) optionally purifying the crude product using Soxhlet extraction to obtain the covalent organic framework.

6. The method as claimed in claim 5, wherein the solvent is selected from dioxane, mesitylene, tetrahydrofuran, dimethylformamide, acetonitrile, ethyl acetate, or a combination thereof.

7. The method as claimed in claim 5, wherein the time period of the reaction of step (a) is 5 days.

8. A covalent organic framework derived Na-ion battery electrode comprising of the covalent organic frame work as claimed in any one of the claims 1 to 4 coated with Na metal.

9. The covalent organic framework derived Na-ion battery electrode as claimed in claim 8, wherein the covalent organic framework is 2,4,6-trihydroxybenzene-1,3,5-tricarbaldehyde and 5,5′-(1,2,4,5-tetrazine-3,6-diyl)bis(pyridin-2-amine).

10. The covalent organic framework derived Na-ion battery electrode as claimed in claim 8, wherein the covalent organic framework is IISERP-COF18.

11. A method of preparation of a covalent organic framework derived Na-ion battery electrode, wherein the method comprising the step of:
(a) dispersing a covalent organic framework in ethanol to obtain ethanolic dispersion of the covalent organic framework;
(b) coating the ethanolic dispersion of the covalent organic framework on a carbon paper; and
(c) drying the carbon paper in vacuum for 12-24 hours to obtain electrode; and
(d) fabricating the electrode using Na metal to obtain the covalent organic framework derived Na-ion battery electrode.

12. The method as claimed in claim 11, wherein the carbon paper is carbon coated aluminium foil.
